(19) United States
(12) Patent Application Publication
(10) Pub. No.: US 2025/0253065 A1
(43) Pub. Date: Aug. 7, 2025

(54) LASER FUSION REACTOR

(71) Applicant: Malcolm McGeoch, Little Compton, RI (US)

(72) Inventor: Malcolm McGeoch, Little Compton, RI (US)

(21) Appl. No.: 19/047,322

(22) Filed: Feb. 6, 2025

Related U.S. Application Data
(60) Provisional application No. 63/550,167, filed on Feb. 6, 2024.

(51) Int. Cl. G21B 1/03; G21B 1/11; G21B 1/13; G21B 1/17; G21B 1/19

(52) U.S. Cl. CPC G21B 1/03; G21B 1/13; G21B 1/17; G21B 1/19; G21B 1/115

(57) ABSTRACT

A laser fusion reactor assembly comprises magnet coils to produce magnetic field cusps at opposing ends of the reactor. The magnetic field cusps guide energetic ions to ion beam dumps of increased surface area to capture and remove ion-generated heat from the fusion reaction and reactor assembly.

### CROSS-REFERENCE TO RELATED APPLICATION(S)

This application claims the priority benefit, under 35 U.S.C. 119(e), of U.S. Application No. 63/550,167, titled “Laser Fusion Reactor,” filed Feb. 6, 2024, which application is incorporated herein by reference in its entirety for all purposes.

### BACKGROUND

Direct-drive laser fusion has been the subject of research since the early 1970's. However, there currently is no direct-drive laser fusion reactor suitable for commercialization that produces excess energy. For direct-drive laser fusion, laser beams are focused on a target to heat and compress the target to initiate a fusion reaction.

### SUMMARY

The present invention relates to a laser fusion reactor assembly for direct-drive laser fusion. The laser fusion reactor assembly comprises magnetic field coils to generate magnetic fields that protect a majority of the interior wall surface of the reactor from energetic ions. The generated magnetic fields also form two magnetic field cusps at opposing ends of the reactor that guide the flux of ions from the heated target onto ion beam dumps that can absorb the energetic ions. The laser fusion reactor assembly further comprises a double-wall structure with a sheath space between an inner wall and outer wall to permit flow of a gas (e.g., helium gas) at low pressure for cooling purposes. A tritium breeder blanket can be installed in the sheath space and cooled by the flowing gas.

Some implementations relate to a laser fusion reactor assembly to house fusion reactions. An example reactor assembly can comprise: a chamber in which to establish a vacuum environment, the chamber having a first end disposed along a central axis of the chamber and a second end disposed a distance from the first end along the central axis; an inner wall defining a first wall of the chamber; an outer wall defining a second wall of the chamber; a sheath space between the inner wall and the outer wall to permit flow of a gas between the inner wall and the outer wall; a first set of magnetic coils to produce a first magnetic field with field lines oriented axially in the chamber, running parallel to the central axis; a second set of magnetic coils located at the first end of the chamber to produce a second magnetic field opposing the first magnetic field at the first end of the chamber such that a first radially-oriented magnetic field cusp is formed within the chamber; a first ion beam dump disposed along the inner wall to receive first ions from the fusion reactions that are guided from a central region of the chamber along the first radially-oriented magnetic field cusp to the first ion beam dump; a third set of magnetic coils located at the second end of the chamber to produce a third magnetic field opposing the first magnetic field at the second end of the chamber such that a second radially-oriented magnetic field cusp is formed within the chamber; and a second ion beam dump disposed along the inner wall to receive second ions from the fusion reactions that are guided from the central region of the chamber along the second radially-oriented magnetic field cusp to the second ion beam dump.

Some implementations relate to methods of operating the laser fusion reactor assembly described in the preceding paragraph. Such methods can comprise acts of: injecting deuterium-tritium target pellets into the chamber of claim 1; initiating direct-drive ignition of the target pellets in the chamber with a plurality of laser beams; protecting, with the first magnetic field, a majority of a plasma-facing surface of the inner wall from ion flux produced by the direct-drive ignition of the target pellets; guiding, along the first radially-oriented magnetic field cusp, the first ions to the first ion beam dump disposed at the first end of the chamber; and guiding, along the second radially-oriented magnetic field cusp, the second ions to the first ion beam dump disposed at the second end of the chamber.

Some implementations relate to a laser fusion reactor system comprising direct-drive ignition of deuterium-tritium targets injected into an evacuated chamber that has its plasma-facing wall protected by an applied magnetic field that is aligned with a symmetry axis of the chamber, with field lines leading to magnetic cusps disposed at each end of the chamber, which field configuration serves to guide fusion product ions out of the chamber onto two ion dumps, one at each end, the reactor including tritium breeder blanket regions outside of the chamber plasma-facing wall and a helium coolant flow to remove heat and manufactured tritium from the blanket regions.

All combinations of the foregoing concepts and additional concepts discussed in greater detail below (provided such concepts are not mutually inconsistent) are part of the inventive subject matter disclosed herein. In particular, all combinations of subject matter appearing in this disclosure are part of the inventive subject matter disclosed herein. The terminology used herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally and/or structurally similar elements).

FIG. 1 depicts, in elevation view, an example of a laser fusion reactor assembly with a surrounding tritium breeder blanket and laser beam entry tubes that converge on a central target location.

FIG. 2 depicts the reactor assembly of FIG. 1 with early expansion of the fusion plasma as it compresses the axial magnetic field against the conductive chamber wall.

FIG. 3 depicts the reactor assembly of FIG. 1 showing a later time disposition of the fusion plasma as it streams energetic ions toward the ion beam dump surfaces.

FIG. 4 depicts, in cross section, an example tritium breeder blanket design for the reactor assembly of FIG. 1.

FIG. 5 depicts coolant gas introduction and exhaust through a tritium breeder blanket via sparge tubes.

FIG. 6 plots the flow power required for helium cooling versus the helium pressure.

FIG. 7 illustrates a cross-sectional view of the coolant gas flow channels adjacent to the ion beam dumps.

### DETAILED DESCRIPTION

### 1. Introduction

The inventor has recognized and appreciated that short wavelength lasers (e.g., 351 nm or less) and emitting a broad range of frequencies (e.g., up to 10 THz, around a central wavelength) are very suitable for direct-drive laser fusion reactors. For the ArF laser operating at a wavelength of 193.3 nm (frequency of 1551 THz), it has been shown that amplifier chains delivering greater than 60 kJ can generate greater than 10 THz bandwidth (S. P. Obenschain et al., “Direct drive with the argon fluoride laser as a path to high fusion gain with sub-megajoule laser energy”, Phil. Trans. Roy. Soc. A378, 20200031 (2020)). Such laser systems, operating in parallel to provide a total of 500 kJ on target, theoretically can provide stable compression to achieves a gain of up to 150, defined as fusion energy emitted divided by laser energy applied (A. J. Schmitt and S. P. Obenschain, “The importance of laser wavelength for driving inertial confinement fusion targets. II. Target design”. Phys. Plasmas 30, 012702 (2023).

The inventor has also recognized and appreciated that heating and compression of the laser fusion target results in a high flux of energetic ions that can rapidly degrade and damage the inward facing walls in the reactor. For example, the immediate product of target ignition in laser direct-drive fusion is a sub-nanosecond burst of neutrons of 14.1 MeV energy and predominantly doubly-ionized helium atoms (alpha particles) of 3.5 MeV energy, expanding uniformly in all directions. The D-T reaction itself is:

$$D + T \to n ( 14.1 MeV ) + alpha ( 3.5 MeV ) . \qquad ( 1 )$$

Other target materials such as carbon and hydrogen also can become ionized in the process and can be ejected at lower energies. The inventor has recognized and appreciated that the flux of energetic ions must be handled in a suitable way within the reactor such that a reactor can operate over extended periods of time without shutting the reactor down frequently to replace damaged walls.

The inventor has further recognized and appreciated that a D-T reactor should be capable of producing tritium. Tritium is not available naturally because it decays with a half-life of 12.3 years. Thus, it is highly desirable for a reactor that consumes tritium to also produce at least its own supply of tritium for continued operation. Deuterium is readily available from the ocean.

### 2. Laser Fusion Reactor Assembly

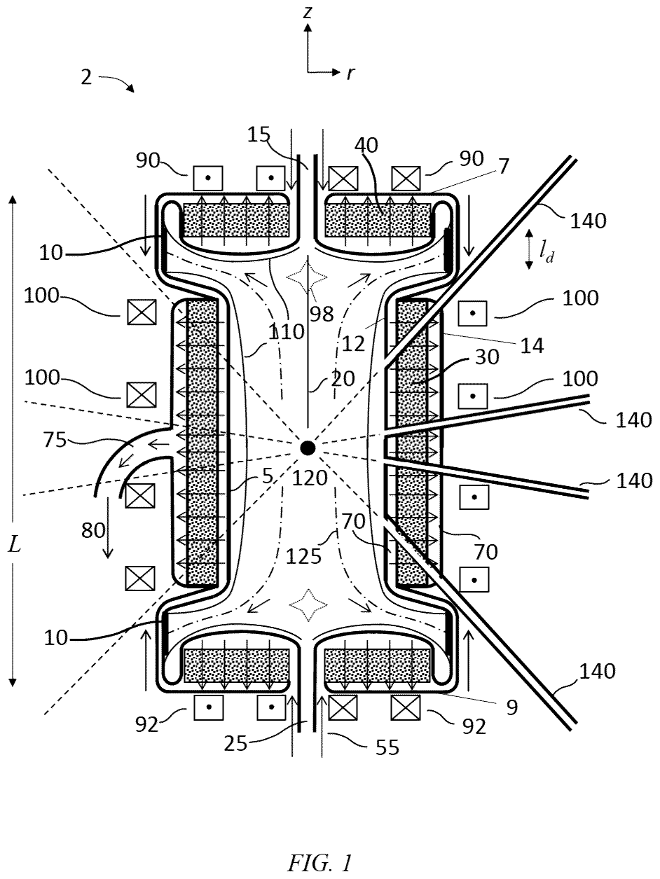

One approach to handling the flux of energetic ions is by magnetic intervention. In this approach, magnetic fields are produced inside the chamber to guide energetic ions away from chamber walls to a location where the ions can be absorbed. FIG. 1 depicts a reactor chamber assembly 2 that employs magnetic intervention to handle the flux of energetic ions following a fusion reaction.

The reactor assembly 2 comprises a vacuum chamber 5 having a central axis 20 extending centrally through a length L of the chamber 5. The vacuum chamber 5 can support a vacuum environment and house fusion reactions occurring at a central region 120 within the chamber. In some implementations, the chamber can be symmetric or mostly symmetric about the central axis. The chamber 5 can be cylindrical in shape, having a circular or essentially circular cross section, or may have a polygonal cross section (e.g., hexagonal, octagonal, square, etc.). In some implementations, the chamber 5 is oriented vertically at an installation site such that the central axis 20 is perpendicular to the ground. The vacuum chamber 5 can have a double-wall structure with an inner wall 12 and an outer wall 14. There can be a sheath space 70 between the inner wall 12 and the outer wall 14 through which a coolant gas (such as helium) can flow. The length L of the reactor assembly 2 can be from 10 meters to 40 meters.

There can be exit ducts 75 for the coolant gas that are arrayed around the chamber 5 on one set of evenly spaced longitudes. The exit ducts 75 can fluidically couple to the sheath space 70. There can also be laser beam entry tubes 140 that are arrayed around the chamber on a different set of evenly spaced longitudes. These entry tubes 140 can be arranged to provide optical paths for receiving laser radiation (such as ArF radiation at 193 nm) into a central region 120 of the vacuum chamber 5. In some cases, the entry tubes 140 can be fluidically coupled to the central region 120 of the vacuum chamber 5, such that the interior of the entry tubes 140 are under vacuum.

The vacuum chamber 5 can have an entrance port 15 at a first end 7 of the chamber 5 for injection of fusion targets. There can be an exit port 25 at a second end 9 of the chamber for vacuum pumping purposes. Fusion targets can be tracked during flight to the central region 120 where intense few-nanosecond laser pulses arrive simultaneously from multiple directions to initiate the heating and compression of the fusion target and the fusion burn.

The inner wall 12 can be surrounded by continuous sheath space 70, bounded by the outer wall 14, that admits incoming coolant gas flow 55 (e.g., helium) into both ends of the sheath space 70. The coolant gas can be guided between the inner wall 12 and outer wall 14 to first flow through end tritium breeder blankets 40, then past ion beam dumps 10 toward the central waist of the chamber 5. At the central waist, the coolant gas can flow outward through a sidewall tritium breeder blanket 30 to exit the reactor via the exit ducts 75, progressing along flow paths 80 to heat exchangers and turbines. The sidewall tritium breeder blanket 30 can surround, partially or fully, the central axis 20 and be located in the sheath space 70.

Circular axial magnetic field coils 100, surrounding the chamber 5 and sidewall tritium breeder blanket 30 can be driven with electric currents to generate a steady magnetic field inside the chamber 5. The magnetic field orientation is predominantly axial in the central region of the chamber 5 (running in the +z or −z direction indicated in the drawing). Circular end field coils 90, 92 adjacent to the end tritium breeder blankets 40 provide magnetic fields opposed to the field of axial magnetic field coils 100, creating magnetic field nulls 98 at two locations along the central axis 20, one close to each end of the chamber. These magnetic field nulls 98 are centrally located within two magnetic field cusps near the two opposing ends of the vacuum chamber 5. Each magnetic field cusp is associated with magnetic field lines 110 turning to a radial orientation within the chamber 5. These radially-oriented magnetic field lines 110 converge toward the central axis 20 and extend outward in all radial directions toward ion beam dumps 10 disposed along the inner wall 12.

There can be two ion dumps 10 in the reactor assembly 2, one at each end 7, 9 of the chamber 5. The ion beam dumps 10 can be cylindrical in shape (e.g., ring-shaped), each extending a length l_{d}, though other shapes are possible. The ion beam dumps 10 can be disposed symmetrically around the central axis 20. The ion beam dumps 10 can be cooled via thermal coupling and heat transport to an outer surface of the inner wall 12, which can be cooled by gas flow through the sheath space 70. For example, helium gas can flow through the sheath space 70 to cool the outer surface of the inner wall 12 at the location of the ion beam dumps 10. In some implementations, the sheath space 70 can be narrowed at the location of the ion beam dumps 10 to increase the velocity of coolant gas across the outer surface of the inner wall 12 and thereby increase the rate of cooling of the ion beam dumps 10.

In operation, a spherical deuterium-tritium target pellet containing fusion fuels deuterium and tritium can be injected via the entrance port 15 toward the central region 120. The laser pulses can be timed such that the target pellet, when arriving at the central region 120, is irradiated by multiple laser beams focused onto the target pellet through the laser beam entry tubes 140, which all essentially point toward the central region 120 of the chamber 5. The laser beams converge in a carefully designed set of directions via the entry tubes 140. The entry tubes 140 can pass through the sidewall tritium breeder blanket 30 and are sealed to prevent inflow of the coolant gas in the sheath space 70.

The intensity of the converging laser beams onto the target's surface should be uniform to less than 0.5% root mean square deviation from exact spherical uniformity. The laser fusion reaction products are neutrons, fast helium ions and other ionized elements from the target construction. The 14.1 MeV fusion neutrons carrying about 80% of the fusion energy and the 3.5 MeV helium ions carrying about 20% are launched isotropically from central region 120. An additional much smaller amount of energy remains in an expanding plasma comprising the ionized structural elements from the target, such as carbon, and electrons.

Initially the expanding wave of helium ions pushes against the magnetic field lines 110 that run approximately parallel to central axis 20 in the vicinity of the central region 120. The helium ions begin to execute Larmor precession around the field lines, but a stronger effect, related to space charge, begins to dominate the outward motion of the ions, while the neutrons proceed free from any significant interaction toward inner wall 12 and ultimately into the sidewall tritium breeder blanket 30 (extending parallel to the central axis 20 of the chamber 5) and end tritium breeder blankets 40 (extending perpendicular to the central axis 20). The space charge field of fusion helium ions becomes very large, attracting electrons to move outward. Electrons, however, are more strongly affected by the applied magnetic field than ions, therefore they begin rapid azimuthal motion around central axis 20, generating in the process a magnetic field that cancels the inner region of magnetic field between the central region 120 and the electron sheath, while adding to the field strength outside of the electron sheath. This additionally constrains helium ions to move in reduced Larmor radii, so that together the electrons and ions push the magnetic field outward while their kinetic energy becomes converted into magnetic field energy of compression.

The purpose of the applied magnetic fields from the axial magnetic field coils 100 and end field coils 90, 92 is to guide ions and electrons toward ion beam dumps 10 where the structure is designed to handle the heat pulse from the ion flux. The inner wall 12 is formed from a conductive metal, which may include reduced activation ferritic steel. The inner wall 12 can be coated, at least in part, with a tungsten surface layer facing the central region 120. The electrical conductivity of inner wall 12 can be sufficiently high to imply an electromagnetic skin depth much less than the total material thickness of the inner wall 12, if calculated for the few microseconds plasma residence time in the chamber. The compressed magnetic field cannot penetrate the inner wall 12 on this timescale, causing a build-up in magnetic field strength due to the plasma expansion already described.

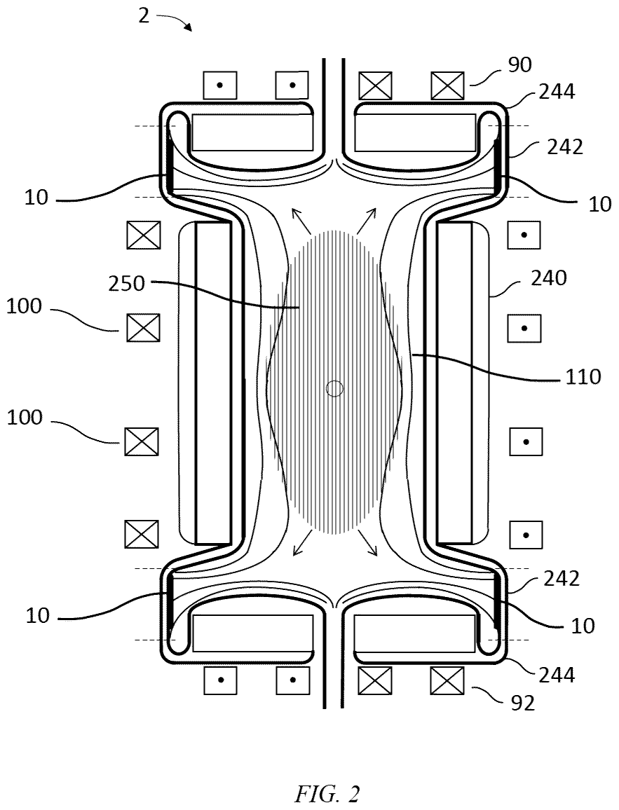

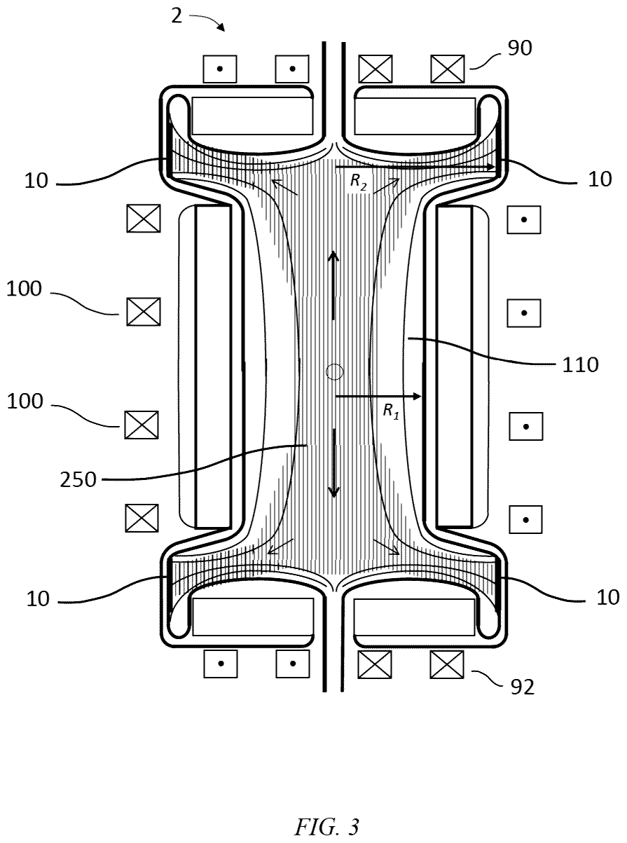

Outward plasma motion ceases when the magnetic field reaches the value at which essentially all of the fusion alpha particle energy has been converted into energy of a compressed magnetic field. The cessation of outward plasma motion is depicted in FIG. 2. The plasma 250 then expands freely along the applied field lines toward the first end 7 and second end 9 of the chamber until it reaches the opposed magnetic field regions driven by the end coils 90, 92. The opposing radially-oriented magnetic field and magnetic cusps created by the end magnetic coils 90, 92, guide the plasma 250 to move radially outward toward the ion beam dumps 10, where ionic energy is intercepted. This outward radial expansion of the plasma 250 is depicted in FIG. 3.

The whole process of expansion, temporary containment and ejection can take of the order of 2 microseconds. Plasma instabilities do not have sufficient time to grow, therefore a very small fraction of the fusion alpha particle energy strikes the central portion of chamber's inner wall 12 between the ion beam dumps 10, thereby avoiding surface erosion at the same time as reducing the operational temperature of the inner wall material. In some implementations, the ion beam dumps 10 comprise a region of the inner wall 12 coated on the interior with tungsten or another material. In some cases, the coating can extend over a larger portion of the inner wall 12 or over the entire inner wall 12 but can be thicker at the locations of the ion beam dumps 10.

For the reactor design of FIG. 1, essentially all of the fusion energy can be transferred to the helium coolant flow, by thermal coupling and heat transport through the inner wall 12 and into the coolant gas and/or by thermal coupling to and heat transport into the coolant gas from the tritium breeder material of the sidewall tritium breeder blanket 30 and end tritium breeder blanket 40, where essentially all of the neutron energy has been deposited.

Following the fusion ignition event (initiated by laser pulses heating and compressing the target pellet), residual gases that include un-burned deuterium and tritium fuel can be pumped out of the chamber from the exit port 25 for subsequent tritium recovery. The evacuation of the gases and fuel also prepare the chamber vacuum for the succeeding target pellet injection, laser shot, and fusion ignition event.

The axial magnetic field coils 100 are configured to provide a steady magnetic field (indicated by field lines 110) that is sufficient to stop and turn around the fusion plasma ionic products. The magnetic field for this purpose can be estimated. To simplify the estimate, a fusion release of energy Q₀ per unit of axial length in a cylindrical geometry is considered. The cylinder's radius is R, the steady applied field is denoted as B, and the maximum plasma radius is denoted as R_{C}. Without being bound to a particular theory, the ratio of the maximum radius of the plasma to cylinder radius can be expressed as follows:

$$\frac{{R}_{C}}{R} = \frac{1}{\sqrt{1 + \frac{{R}^{2} {B}^{2}}{2 {}_{0} {Q}_{0}}}} \qquad ( 2 )$$

where μ₀ is the permittivity of free space. The ratio of the maximally compressed magnetic field B_{c} to the initial field B can be expressed as follows:

$$\frac{{B}_{C}}{B} = 1 + \frac{2 {}_{0} {Q}_{0}}{{R}^{2} {B}^{2}} . \qquad ( 3 )$$

For example, for a total fusion energy release of 100 MJ with R=4 m and B=0.5 T, the ion component represents Q₀=20 MJ/m, and we find R_{C}/R=0.894 and B_{C}/B=4.98 with a final magnetic field radial thickness of 0.42 m. Such a condition is depicted in FIG. 2.

The reactor assembly 2 of FIG. 1 provides radial containment of the plasma 250 in a central region of the chamber 5 to protect a majority of the inner wall 12 in the central region of the chamber. The reactor assembly is not designed to contain the plasma 250 for long durations of time to prevent contact of the plasma with any wall inside the chamber 5. The inventor has recognized and appreciated that containment of the plasma for millisecond time scales could result in the development of undesirable plasma instabilities. Instead, the reactor assembly 2 is configured to guide the plasma directly, and as quickly as possible, onto ion beam dumps 10 (as depicted in FIG. 3) where heat from the fusion ion energy can be added to heat from hot neutrons entering the breeder blanket. Heat from these two sources can be coupled into the coolant gas in the sheath space 70 and transported by the coolant flow to where the heat can be harnessed for electricity production (e.g., to a turbine).

The reactor assembly 2 has several desirable features with regard to dissipation of heat by the ion flux. By locating the magnetic field cusps and ion beam dumps 10 near the ends of the reactor, rather than near a central region 120 of the reactor, the ion beam dumps 10 do not interfere with access to the central region 120 by the laser beam entry tubes 140. By forming two magnetic field cusps near each end of the chamber 5, rather than a single central cusp, the surface area over which the ion flux is absorbed can be doubled. Further, locating the magnetic field cusps at the ends of the chamber allows the radius R₂ to the ion beam dump 10 to be increased compared to the radius Ry at the central region of the chamber 5 again without interfering with access to the central region 120 by the laser beam entry tubes 140. This increase in radius further permits an increase in surface area of the ion beam dumps 10 over which heat can be dissipated. The ratio of radii R₂/R₁ can be from 1.2 to 5. Additionally, the location of the ion beam dumps 10 near the ends of the chamber 5 allows the coolant gas to cool the beam dumps 10 before the coolant gas is heated by the sidewall tritium breeder blanket 30.

The narrowing of the sheath space adjacent to the ion beam dumps 10 can increase coolant gas flow velocity across the section of the inner wall 12 that thermally couples to the ion beam dumps 10, as described above. That is, the coolant gas flow velocity adjacent to the ion beam dumps 10 can be greater than the coolant gas flow velocities before and after the section of the inner wall 12 that thermally couples to the ion beam dumps 10. In some implementations, the narrowing of the sheath space adjacent to the ion beam dumps 10 can allow for thermal coupling of heat to the outer wall in this region of the chamber 5.

The tritium breeding blankets 30, 40 of the present invention can comprise lead (Pb) in the form of a Pb-containing ceramic, as the neutron multiplier. The Pb neutron multiplication reaction can be expressed as:

$$n + {}^{208} Pb + 7.4 MeV \to {}^{209} {Pb}^{*} \to {}^{207} Pb + 2 n + E ( gamma ) \qquad ( 4 )$$

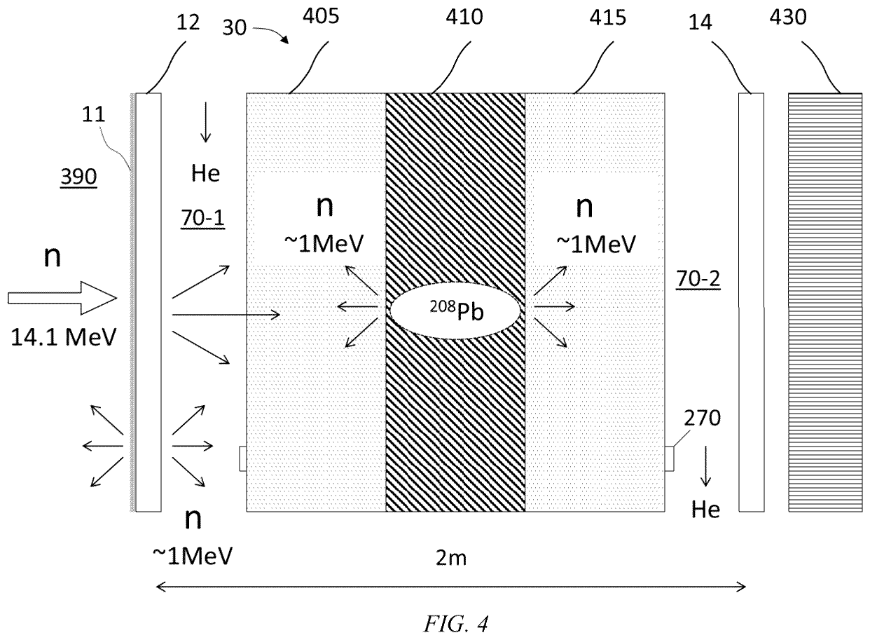

with a threshold energy of 7.4 MeV and cross section approximately 2 barns between 7.4 MeV and 14 MeV. (C. Y. Fu and F. G. Perey, “An evaluation of neutron and gamma-ray-production cross-section data for lead”, At. Data and Nucl. Data Tables 16, 409-450 (1975)) The two secondary neutrons are emitted with an energy of about 1 MeV each and are emitted isotropically according to Fu and Perey. In order to most efficiently utilize this isotropic source of 1 MeV neutrons to create tritium via reaction with ⁶Li, the lithium-bearing ceramic can be positioned on both sides of a Pb ceramic layer within the breeder blankets, as illustrated in FIG. 4.

FIG. 4 depicts, in cross section, an example tritium breeder blanket design for the reactor assembly 2. In FIG. 4, the energetic neutrons impinge on the inner wall 12 from a region 390 inside the reactor chamber 5. The inner wall 12 can comprise reduced activation ferritic-martensitic (RAFM) steel. At least a portion of the inner plasma-facing surface of the inner wall 12 can have a tungsten protective layer 11 in order to withstand the temperature impulse of X-rays from the plasma, and some residual ions that collisionally penetrate the axial magnetic field. An inner portion 405 and an outer portion 415 of the breeder blankets 30, 40 can contain ⁶Li-bearing ceramic pebbles and can be porous to permit gas flow through these portions. A central portion 410 of the breeder blankets 30, 40 can contain ²⁰⁸Pb-bearing ceramic pebbles and can also be porous to permit gas flow through the central portion. In some implementations, the ceramic pebbles comprise lead titanate (PbTiO₃). The outer wall 14 can comprise RAFM steel. A neutron reflector 430 comprising graphite can be mounted adjacent to the outer wall 14 to return neutrons to the breeder blankets. The distance between the inner wall 12 and the outer wall 14 at the locations of the breeder blankets 30, 40 can be from 1 meter to 3 meters or larger in some cases.

Coolant gas flow (e.g., helium flow) is designed to pass through the portions of the breeder blanket 30 in an outward flow direction. For example, helium gas can enter an inner sheath-space region 70-1, between the inner wall 12 and the inner portion 405 of the breeder blanket 30. The helium flows sequentially through the inner portion 405, the central portion 410, and the outer portion 415 of the breeder blanket 30 and into an outer sheath-space region 70-2. From the outer sheath-space region 70-2, the helium can flow toward the exit ducts 75 (illustrated in FIG. 1). Tritium produced in the breeder blankets 30, 40 can be transported by the coolant gas flow out of the sheath space 70 for separation and harvesting.

Partial neutron energy deposition can occur in the inner wall 12, where the dominant interactions are elastic and inelastic forward scattering, and a minor interaction creates low energy secondary neutrons (approximately at 1 MeV) via the ⁵⁶Fe (n,2n) process. 14 MeV neutrons and energy-degraded neutrons may be further scattered in the lithium-bearing ceramic inner portion 405 of the breeder blanket 30 before entering the Pb ceramic central portion 410. In the central portion 410, there is substantial conversion into approximately 1 MeV neutrons via the ²⁰⁸Pb (n,2n) process, and these daughter neutrons are emitted isotropically. For this reason, in order to increase tritium breeding via the n+⁶Li→³H+⁴He process, the lithium-bearing ceramic inner portion 405 and outer portion 415 are disposed on both sides of Pb-containing central portion 410, sandwiching the central portion.

In some implementations, a small amount of oxygen (O₂) can be added to the helium flow to create a low percentage of O₂ in the coolant gas (e.g., less than 1% by volume). Typically, the coolant gas comprises at least 99% helium. The O₂ can react with tritium to form water analog T₂O which can be condensed or adsorbed elsewhere in the helium flow loop to extract tritium.

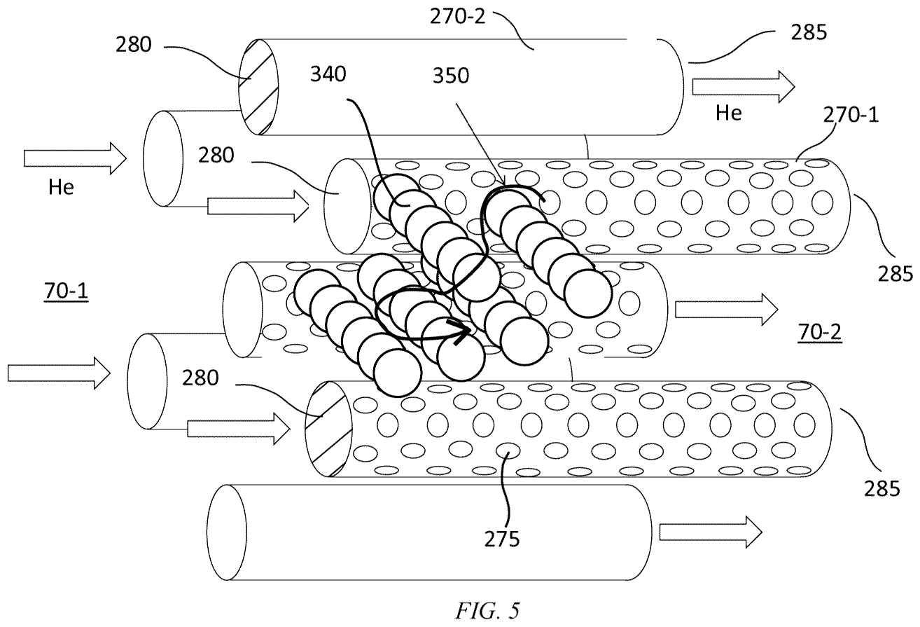

FIG. 5 depicts coolant gas introduction into the breeder blankets and exhaust via sparge tubes 270-1, 270-2 (generally referred to as sparge tubes 270). The breeder blankets 30, 40, comprise beds of ceramic pebbles 340 (some of which are illustrated in the drawing). When relatively small ceramic pebbles 340 are used, of the order 1 mm in diameter, the pressure drop in small passageways between pebbles can be significant and can be calculated. To reduce this pressure drop, the coolant gas (He in this example) can be introduced into the pebble beds of the breeder blankets 30, 40 via sparge tubes 270, as depicted in FIG. 5. The sparge tubes 270 can be embedded in the breeder blankets 30, 40 and oriented with a long axis approximately aligned to the general direction of coolant gas flow through the breeder blankets 30, 40, as illustrated in FIG. 5. The sparge tubes 270 can pass partly or fully through the breeder blankets 30, 40. The sparge tubes 270 can comprise perforations 275 (illustrated for some of the tubes) that allow helium exit and re-entry but prevent the pellets from passage. The perforations (e.g., small holes) can be distributed along a length of the sparge tubes 270 that are embedded in the tritium breeder blanket. The sparge tubes can occupy from 5% to 10% of the total volume of the breeder blanket, where the total volume includes the portion occupied by the sparge tubes 270. The sparge tubes 270 are closed at one end and open at the opposite end.

There can be two orientations of the sparge tubes 270 within the breeder blankets 30, 40, as depicted in FIG. 5. First, entry sparge tubes 270-1 are open at a near end 280 (upstream in the general direction of coolant gas flow through the breeder blanket) and closed at a distal end 285 (downstream in the coolant gas flow). Second, exit sparge tubes 270-2 are closed at the near end 280 but open at the distal end 285. The entry sparge tubes 270-1 can provide unimpeded fluidic coupling with the inner sheath-space region 70-1 (also see FIG. 4) to admit coolant gas into the entry sparge tubes 270-1. The exit sparge tubes 270-2 can provide unimpeded fluidic coupling with the outer sheath-space region 70-2 to exhaust coolant gas from the exit sparge tubes 270-2. Helium, for example, enters an entry sparge tube 270-1 at the open near end 280, leaves the tube via perforations 275, flows between the ceramic pebbles 340 in a typical circuitous path 350, then re-enters an exit sparge tube 270-2 at perforations 275 to leave at the distal end 285 of the exit sparge tube.

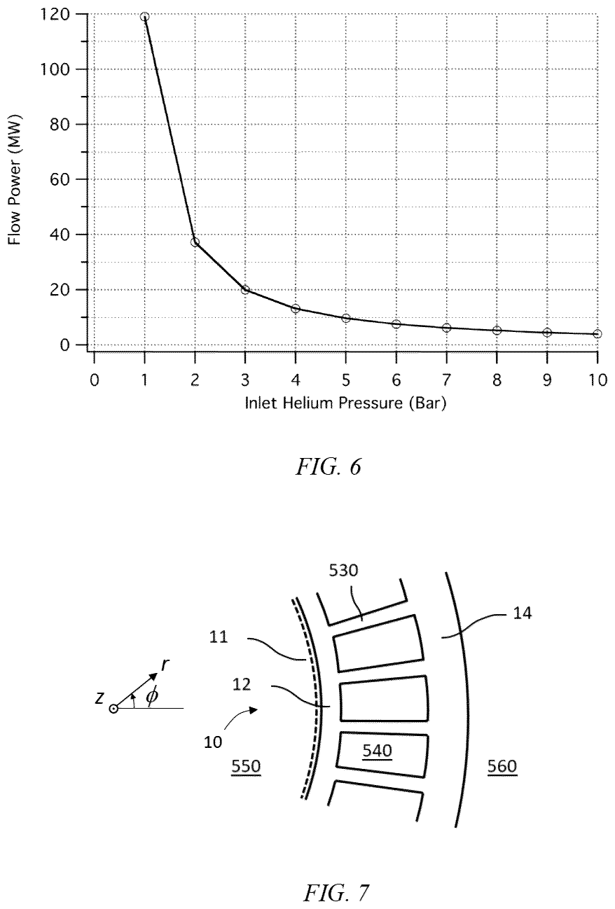

A certain mechanical power is applied to move helium around the cooling loop that links the internal reactor sheath space 70 with external heat exchangers and turbines (not shown in the drawings). Considering the in-reactor flow power alone, including the pressure drops in sparge tubes 270, exit and entry holes in these tubes, and in the paths through ceramic pebbles 340, a fluid dynamics model can predict the flow power as a function of helium coolant pressure. The results are plotted in FIG. 6. Acceptable flow power is predicted for a helium pressure of about 5 Bar. In some implementations, the reactor assembly 2 operates with coolant gas pressure in a range from 2 Bar to 10 Bar to induce flow of the coolant gas through the sheath space 70. This amount of working pressure is considerably less than other fusion reactor designs that operate at over 100 Bar of helium pressure, which is difficult to engineer without leakage.

FIG. 7 illustrates a cross-sectional view of coolant gas flow channels 540 adjacent to the ion beam dumps 10 for a portion of the chamber 5. The flow channels 540 partition the coolant gas flowing past the ion beam dumps 10. The view is looking in the −z direction. The coolant gas flows behind ion beam dumps 10 along axial ±z directions with respect to the chamber 5, differently from outward or inward flow at the breeder blankets 30, 40. The inner plasma-facing surface of the ion dumps may have tungsten protective layer 11 in order to withstand the temperature impulse of ions transported through the interior vacuum region 550 and guided by magnetic field lines of the magnetic cusps to the ion beam dumps 10 at each end of the chamber 5. These energetic ions are stopped within the first few tens of microns in tungsten protective layer 11. Most of their heat is conducted through the inner wall 12 and thermally coupled into coolant gas flowing through the flow channels 540 which transports the heat away from the ion beam dumps 10.

For implementations where the inner wall 12 is constructed from reduced activation ferritic martensitic steel with a relatively low thermal conductivity, the inner wall 12 (sometimes referred to as a shell) may be relatively thin (of the order of 1 cm, e.g., from 0.5 cm to 2 cm). Such a thin wall, given the potentially high electromagnetic forces and heating involved, can benefit from additional mechanical support. Such mechanical support can be provided with structural members 530 (e.g., fins, rods, or plates) that communicate structurally with a more substantial outer wall 14. The outer wall can be thicker than the inner wall by a factor of 1.5 to 5 in a region of the chamber adjacent to the ion beam dumps 10.

In some implementations, the region of the chamber 5 depicted in FIG. 7 can be a replaceable portion of the chamber. For example, a cylindrical portion 242 at each end of the chamber 5, indicated by dashed lines in FIG. 2, can mechanically couple to and decouple from the central portion 240 of the chamber and an adjacent end portion 244 of the chamber. Since the ion beam dumps 10 are located at the ends of the chamber 5, they can be replaced without disrupting the beam entry tubes 140 and tubing connected to exit ducts 75.

### 3. Conclusion

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that inventive embodiments may be practiced otherwise than as specifically described. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

Unless stated otherwise, the terms “approximately” and “about” are used to mean within ±20% of a target (e.g., dimension or orientation) in some embodiments, within ±10% of a target in some embodiments, within ±5% of a target in some embodiments, and yet within ±2% of a target in some embodiments. The terms “approximately” and “about” can include the target. The term “essentially” is used to mean within ±3% of a target.

The indefinite articles “a” and “an,” as used herein, unless clearly indicated to the contrary, should be understood to mean “at least one.”

The phrase “and/or,” as used herein, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” shall have its ordinary meaning as used in the field of patent law.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A laser fusion reactor assembly to house fusion reactions, the laser fusion reactor assembly comprising:
a chamber in which to establish a vacuum environment, the chamber having a first end disposed along a central axis of the chamber and a second end disposed a distance from the first end along the central axis;
an inner wall defining a first wall of the chamber;
an outer wall defining a second wall of the chamber;
a sheath space between the inner wall and the outer wall to permit flow of a gas between the inner wall and the outer wall;
a first set of magnetic coils to produce a first magnetic field with field lines oriented axially in the chamber, running parallel to the central axis;
a second set of magnetic coils located at the first end of the chamber to produce a second magnetic field opposing the first magnetic field at the first end of the chamber such that a first radially-oriented magnetic field cusp is formed within the chamber;
a first ion beam dump disposed along the inner wall to receive first ions from the fusion reactions that are guided from a central region of the chamber along the first radially-oriented magnetic field cusp to the first ion beam dump;
a third set of magnetic coils located at the second end of the chamber to produce a third magnetic field opposing the first magnetic field at the second end of the chamber such that a second radially-oriented magnetic field cusp is formed within the chamber; and
a second ion beam dump disposed along the inner wall to receive second ions from the fusion reactions that are guided from the central region of the chamber along the second radially-oriented magnetic field cusp to the second ion beam dump.

2. The laser fusion reactor assembly of claim 1, wherein the chamber is cylindrical in shape and the central axis of the chamber is disposed vertically.

3. The laser fusion reactor assembly of claim 1 further comprising:
a sidewall tritium breeder blanket disposed between the inner wall and the outer wall, extending in a direction parallel to the central axis of the chamber;
a first end tritium breeder blanket disposed between the inner wall and the outer wall at the first end of the chamber, extending in a direction perpendicular to the central axis of the chamber; and
a second end tritium breeder blanket disposed between the inner wall and the outer wall at the second end of the chamber, extending in a direction perpendicular to the central axis of the chamber.

4. The laser fusion reactor assembly of claim 3, wherein the sidewall tritium breeder blanket, the first end tritium breeder blanket, and second end tritium breeder blanket contain lead (Pb) as a neutron multiplier element.

5. The laser fusion reactor assembly of claim 4, wherein the lead is present in a ceramic material.

6. The laser fusion reactor assembly of claim 5, wherein the ceramic material is lead titanate (PbTiO₃).

7. The laser fusion reactor assembly of claim 4, wherein the neutron multiplier element is disposed as a central portion of the sidewall tritium breeder blanket, the sidewall tritium breeder blanket further comprising:
an inner portion disposed adjacent to the central portion between the central portion and the inner wall, the inner portion comprising ceramic pebbles containing ⁶Li; and
an outer portion disposed adjacent to the central portion between the central portion and the outer wall, the outer portion comprising ceramic pebbles containing ⁶Li.

8. The laser fusion reactor assembly of claim 3, wherein the sidewall tritium breeder blanket, the first end tritium breeder blanket, and the second end tritium breeder blanket are cooled by a flow of coolant gas comprising at least 99% helium gas.

9. The laser fusion reactor assembly of claim 8, wherein the helium gas pressure, measured at an inlet to the chamber, is in a range from 2 Bar to 10 Bar.

10. The laser fusion reactor assembly of claim 8, wherein at least the sidewall tritium breeder blanket comprises:
entry sparge tubes embedded in the sidewall tritium breeder blanket; and
exit sparge tubes embedded in the sidewall tritium breeder blanket, wherein at least a portion of the coolant gas passes through the sidewall tritium breeder blanket via the entry sparge tubes and the exit sparge tubes.

11. The laser fusion reactor assembly of claim 8, further comprising:
structural members disposed adjacent to the first ion beam dump and the second ion beam dump and providing mechanical coupling between the inner wall and the outer wall, the structural members arranged to partition the flow of coolant gas into multiple channels.

12. The laser fusion reactor assembly of claim 3, further comprising a plurality of beam entry tubes arranged around the chamber to permit laser beam illumination at a central region of a target pellet injected into the chamber.

13. The laser fusion reactor assembly of claim 12, wherein the plurality of beam entry tubes is at least 40 beam entry tubes and the plurality of beam entry tubes are arranged to achieve less than 0.5% root mean square deviation from exact spherical uniformity of illumination at the central region.

14. The laser fusion reactor assembly of claim 3, configured to receive argon fluoride radiation at 193 nm wavelength to compress and ignite target pellets injected into the chamber.

15. A method of operating a laser fusion reactor assembly, the method comprising:
injecting deuterium-tritium target pellets into the chamber of claim 1;
initiating direct-drive ignition of the deuterium-tritium target pellets in the chamber with a plurality of laser beams;
protecting, with the first magnetic field, a majority of a plasma-facing surface of the inner wall from ion flux produced by the direct-drive ignition of the deuterium-tritium target pellets;
guiding, along the first radially-oriented magnetic field cusp, the first ions to the first ion beam dump disposed at the first end of the chamber; and
guiding, along the second radially-oriented magnetic field cusp, the second ions to the first ion beam dump disposed at the second end of the chamber.

16. A laser fusion reactor system comprising direct-drive ignition of deuterium-tritium targets injected into an evacuated chamber that has a plasma-facing wall protected by an applied magnetic field that is aligned with a symmetry axis of the evacuated chamber, with field lines leading to magnetic cusps disposed at each end of the evacuated chamber, which field configuration serves to guide fusion product ions out of the evacuated chamber onto two ion dumps, one at each end, the laser fusion reactor system including tritium breeder blanket regions outside of the plasma-facing wall and a helium coolant flow to remove heat and manufactured tritium from the tritium breeder blanket regions.
